(19) United States
(12) Patent Application Publication
(10) Pub. No.: US 2026/0347602 A1
(43) Pub. Date: Nov. 5, 2026

(54) THERMOPLASTIC COMPOSITION, METHOD FOR THE MANUFACTURE THEREOF, AND ARTICLES MADE THEREFROM

(71) Applicant: SHPP GLOBAL TECHNOLOGIES B.V., Bergen op Zoom (NL)

(72) Inventors: Wei SHAN, Shanghai (CN); Qin WANG, Shanghai (CN); Xing LIU, Shanghai (CN); Erik SCHWARTZ, Eindhoven (NL); Robert Antonius BORST, Zevenbergen (NL); Roland Sebastian ASSINK, Middelburg (NL)

(21) Appl. No.: 19/105,669

(22) PCT Filed: Aug. 7, 2023
(86) PCT No.: PCT/IB2023/057973

§ 371 Date: Feb. 21, 2025

(30) Foreign Application Priority Data
Aug. 25, 2022 (EP) 22192155.4

(51) Int. Cl. C08L 69/00; C08J 3/20; C08K 3/04; C08K 5/00; C08K 5/42; C08K 5/5399

(52) U.S. Cl. CPC C08L 69/00; C08J 3/203; C08K 5/42; C08K 5/5399; C08J 2369/00; C08J 2467/00; C08K 3/04; C08K 5/0016; C08K 5/005; C08L 2201/02; C08L 2201/08; C08L 2205/025; C08L 2205/035; C08L 2207/20

(57) ABSTRACT

A thermoplastic composition includes particular amounts of a post-consumer recycle polycarbonate; a polycarbon ate-siloxane copolymer, a polycarbonate-ester, or a branched polycarbonate, or a copolycarbonate comprising repeating units derived from a bulky bisphenol group; and optionally, one or more linear homopolycarbonates having a particular melt flow rate. The composition can provide a desirable combination of properties and can be particularly useful for a variety of articles, including consumer electronics.

### CROSS REFERENCE TO RELATED APPLICATION

This application claims priority to and the benefit of European Patent Application No. 22192155.4, filed on Aug. 25, 2022, the contents of which are hereby incorporated by reference in their entirety.

### BACKGROUND

This disclosure relates to polycarbonate compositions, methods of manufacture thereof and to articles comprising the same.

Polycarbonate (PC) are used on a large scale for many applications, including, for example, electronics, mobility, industrial, infrastructure, and healthcare due to their good mechanical, electrical, and flame retardant properties and wide color space. Products with a smaller carbon footprint are becoming more desirable. Post-consumer recycling (PCR) can enable reuse of plastic materials by recycling from final products in the market and converting to raw materials for new products. However, PCR-based materials typically exhibit inferior mechanical properties compared to the corresponding virgin materials, for example due to additional thermal history or degradation that may occur in the recycling process. Moreover, some PCR materials may have color, which may lead to a narrow color space available for final products.

Accordingly, there remains a continuing need for compositions comprising recycled materials which exhibit comparable mechanical properties, flame retardant performance and color space relative to virgin materials. It would be particularly advantageous to provide a composition having a high PCR content.

### SUMMARY

An aspect of the present disclosure is a thermoplastic composition comprising: 30 to 95 weight percent of a post-consumer recycle polycarbonate; and 5 to 70 weight percent of a polycarbonate-siloxane copolymer, or a polycarbonate-ester, or a branched polycarbonate, or a copolycarbonate comprising carbonate repeating units derived from a bulky bisphenol group; and wherein when the composition comprises the polycarbonate-siloxane copolymer, the branched polycarbonate, or the copolycarbonate comprising phthalimidine carbonate repeating units, the composition further comprises 5 to 65 weight percent of a linear polycarbonate homopolymer comprising at least two of an ultra high flow polycarbonate having a melt flow rate of 55 to 85 g/10 minutes, as determined according to ASTM D1238 at 300° C. and 1.2 kg; a high flow polycarbonate having a melt flow rate of greater than 20 to 54 g/10 minutes, as determined according to ASTM D1238 at 300° C. and 1.2 kg; a low flow polycarbonate having a melt flow rate of 5 to 19 g/10 minutes, as determined according to ASTM D1238 at 300° C. and 1.2 kg; and an ultra-low flow polycarbonate having a melt flow rate of less than 5 g/10 minutes, as determined according to ASTM D1238 at 300° C. and 1.2 kg; wherein weight percent of each component is based on the total weight of the composition.

Another aspect of the present disclosure is A method for the manufacture of the composition, the method comprising melt-mixing the components of the composition.

Another aspect is an article comprising the composition.

The above described and other features are exemplified by the following detailed description.

### DETAILED DESCRIPTION

The present inventors have discovered a composition comprising particular amounts of post-consumer recycle polycarbonate, a polycarbonate component (e.g., a virgin polycarbonate), and a combination of linear polycarbonates having particular melt flow rates can provide a desirable combination of properties.

Accordingly, an aspect of the present disclosure is a thermoplastic composition. The thermoplastic composition comprises a post-consumer recycle polycarbonate. As used herein, the term “post-consumer recycle polycarbonate” refers to a polycarbonate that has been previously used in end-use parts, articles, or components, and has been collected or reclaimed after utilization by the end-user or consumer. Thus, for example, it is understood that that the term refers to a polycarbonate material that would have otherwise been disposed of as waste but has instead been collected and recovered (reclaimed) as a material input, in lieu of a new virgin material, for a recycling or manufacturing process. The term is inclusive of such collected or reclaimed materials which have been further treated or processed to facilitate re-use of the material. Thus, for example, the term is inclusive of material that has been reprocessed from collected or reclaimed material by means of a manufacturing process and made into a product or into a component for incorporation into a product. Such recycled polycarbonates can be further processed to ground materials, flakes, or in the form of pellets.

The post-consumer recycle polycarbonate comprises a polycarbonate. “Polycarbonate” as used herein means a homopolymer or copolymer having repeating structural carbonate units of formula (1)

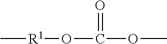

wherein at least 60 percent of the total number of R¹ groups are aromatic, or each R¹ contains at least one C₆₋₃₀ aromatic group. Preferably, each R¹ can be derived from a dibydroxy compound such as an aromatic dihydroxy compound of formula (2) or a bisphenol of formula (3).

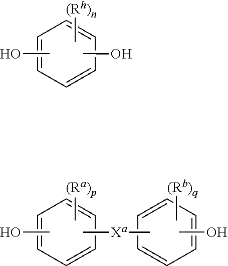

In formula (2), each R^{a} is independently a halogen atom, for example bromine, a C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0 to 4.

In formula (3), R^{a} and R^{b} are each independently a halogen, C₁₋₁₂ alkoxy, or C₁₋₁₂ alkyl, and p and q are each independently integers of 0 to 4, such that when p or q is less than 4, the valence of each carbon of the ring is filled by hydrogen. In an aspect, p and q is each 0, or p and q is each 1, and R^{a} and R^{b} are each a C₁₋₃ alkyl group, preferably methyl, disposed meta to the hydroxy group on each arylene group. X^{a} is a bridging group connecting the two hydroxy-substituted aromatic groups, where the bridging group and the hydroxy substituent of each C₆ arylene group are disposed ortho, meta, or para (preferably para) to each other on the C₆ arylene group, for example, a single bond, —O—, —S—, —S(O)—, —S(O)₂—, —C(O)—, or a C₁₋₁₈ organic group, which can be cyclic or acyclic, aromatic or non-aromatic, and can further comprise heteroatoms such as halogens, oxygen, nitrogen, sulfur, silicon, or phosphorous. For example, X^{a} can be a substituted or unsubstituted C₃₋₁₈ cycloalkylidene; a C₁₋₂₅ alkylidene of the formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl; or a group of the formula —C(═R^{e})— wherein R^{e} is a divalent C₁₋₁₂ hydrocarbon group.

Examples of bisphenol compounds include 4,4′-dihydroxybiphenyl, 1,6-dihydroxynaphthalene, 2,6-dihydroxynaphthalene, bis(4-hydroxyphenyl) methane, bis(4-hydroxyphenyl)diphenylmethane, bis(4-hydroxyphenyl)-1-naphthylmethane, 1,2-bis(4-hydroxyphenyl) ethane, 1,1-bis(4-hydroxyphenyl)-1-phenylethane, 2-(4-hydroxyphenyl)-2-(3-hydroxyphenyl) propane, bis(4-hydroxyphenyl)phenylmethane, 2,2-bis(4-hydroxy-3-bromophenyl) propane, 1,1-bis(hydroxyphenyl)cyclopentane, 1,1-bis(4-hydroxyphenyl)cyclohexane, 1,1-bis(4-hydroxyphenyl) isobutene, 1,1-bis(4-bydroxyphenyl)cyclododecane, trans-2,3-bis(4-hydroxyphenyl)-2-butene, 2,2-bis(4-hydroxyphenyl) adamantane, alpha,alpha′-bis(4-hydroxyphenyl) toluene, bis(4-hydroxyphenyl) acetonitrile, 2,2-bis(3-methyl-4-hydroxyphenyl) propane, 2,2-bis(3-ethyl-4-hydroxyphenyl) propane, 2,2-bis(3-n-propyl-4-hydroxyphenyl) propane, 2,2-bis(3-isopropyl-4-hydroxyphenyl) propane, 2,2-bis(3-sec-butyl-4-hydroxyphenyl) propane, 2,2-bis(3-t-butyl-4-hydroxyphenyl) propane, 2,2-bis(3-cyclohexyl-4-hydroxyphenyl) propane, 2,2-bis(3-allyl-4-hydroxyphenyl) propane, 2,2-bis(3-methoxy-4-hydroxyphenyl) propane, 2,2-bis(4-hydroxyphenyl) hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl) ether, bis(4-hydroxyphenyl) ether, bis(4-hydroxyphenyl) sulfide, bis(4-hydroxyphenyl) sulfoxide, bis(4-hydroxyphenyl) sulfone, 9,9-bis(4-hydroxyphenyl) fluorene, 2,7-dihydroxypyrene, 6,6′-dihydroxy-3,3,3′,3′-tetramethylspiro(bis) indane (“spirobiindane bisphenol”), 3,3-bis(4-hydroxyphenyl) phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole; resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like.

Specific dihydroxy compounds include resorcinol, 2,2-bis(4-hydroxyphenyl) propane (“bisphenol A” or “BPA”), 3,3-bis(4-hydroxyphenyl) phthalimidine, 2-phenyl-3,3′-bis(4-hydroxyphenyl) phthalimidine (also known as N-phenyl phenolphthalein bisphenol, “PPPBP”, or 3,3-bis(4-hydroxyphenyl)-2-phenylisoindolin-1-one), 1,1-bis(4-hydroxy-3-methylphenyl)cyclohexane, and 1,1-bis(4-hydroxyphenyl)-3,3,5-trimethylcyclohexane (isophorone bisphenol).

In an aspect, the post-consumer recycle polycarbonate can have a phenolic end group content of greater than 5 mole percent, preferably 10 to 35 mole percent.

In an aspect, the post-consumer recycle polycarbonate comprises a homopolycarbonate, for example a bisphenol A homopolycarbonate. The post-consumer recycle polycarbonate can comprise residual amounts of one or more additives that were present in the polycarbonate composition prior to recycling.

In an aspect, the post-consumer recycle polycarbonate can have an L value of greater than or equal to 85, preferably greater than or equal to 92, as determined according to ASTM D2244; a yellowness index of less than or equal to 8, preferably less than or equal to 3.5, as determined according to ASTM E313; a transmission of greater than or equal to 70%, preferably greater than or equal to 82% at a thickness of 3 millimeters, determined according to ASTM D1003; and a haze of less than or equal to 10, preferably less than or equal to 6 at a thickness of 3 mm, determined according to ASTM D1003.

The post-consumer recycle polycarbonate can be present in the composition in an amount of 25 to 95 weight percent, based on the total weight of the composition. Within this range, the post-consumer recycle polycarbonate can be present in the composition in an amount of at least 30 weight percent, or at least 35 weight percent, or at least 40 weight percent, or at least 45 weight percent, or at least 50 weight percent. Also within this range, the post-consumer recycle polycarbonate can be present in the composition in an amount of at most 95 weight percent, or at most 85 weight percent, or at most 80 weight percent, or at most 75 weight percent, or at most 70 weight percent. In an aspect, the post-consumer recycle polycarbonate can be present in the composition in an amount of 45 to 90 weight percent, or 45 to 80 weight percent, or 50 to 75 weight percent, or 25 to 55 weight percent, or 30 to 50 weight percent. Combinations of any of the foregoing upper and lower limits are also contemplated herein.

In addition to the post-consumer recycle polycarbonate, the composition further comprises a polycarbonate component that is a polycarbonate-siloxane copolymer, a polycarbonate-ester, a branched polycarbonate, or a copolycarbonate comprising phthalimidine carbonate repeating units polycarbonate copolymer. The aforementioned polycarbonate components are preferably virgin materials.

In an aspect, the polycarbonate component is the polycarbonate-siloxane copolymer. The polycarbonate-siloxane copolymer is preferably a virgin material, that is one which has not been used in end-use parts, articles, or components. The polycarbonate-siloxane copolymer comprises carbonate repeating units according to formula (1) and polysiloxane blocks comprising repeating diorganosiloxane units as in formula (4)

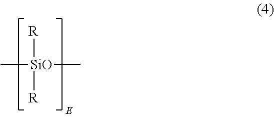

wherein each R is independently a C₁₋₁₃ monovalent organic group. For example, R can be a C₁₋₁₃ alkyl, C₁₋₁₃ alkoxy, C₂₋₁₃ alkenyl, C₂₋₁₃ alkenyloxy, C₃₋₆ cycloalkyl, C₃₋₆ cycloalkoxy, C₆₋₁₄ aryl, C₆₋₁₀ aryloxy, C₇₋₁₃ arylalkylene, C₇₋₁₃ arylalkylenoxy, C₇₋₁₃ alkylarylene, or C₇₋₁₃ alkylarylencoxy. The foregoing groups can be fully or partially halogenated with fluorine, chlorine, bromine, or iodine, or a combination thereof. In an aspect, where a transparent poly(carbonate-siloxane) is desired, R is unsubstituted by halogen. Combinations of the foregoing R groups can be used in the same copolymer.

The value of E in formula (4) can vary widely depending on the type and relative amount of each component in the thermoplastic composition, the desired properties of the composition, and like considerations. Generally, E has an average value of 2 to 1,000, preferably 2 to 500, 2 to 200, or 2 to 125, 5 to 80, or 10 to 70. In an aspect, E has an average value of 10 to 80 or 10 to 40, and in still another aspect, E has an average value of 40 to 80, or 40 to 70. Where E is of a lower value, e.g., less than 40, it can be desirable to use a relatively larger amount of the poly(carbonate-siloxane) copolymer. Conversely, where E is of a higher value, e.g., greater than 40, a relatively lower amount of the poly(carbonate-siloxane) copolymer can be used. A combination of a first and a second (or more) poly(carbonate-siloxane) copolymers can be used, wherein the average value of E of the first copolymer is less than the average value of E of the second copolymer.

In an aspect, the polysiloxane blocks are of formula (5)

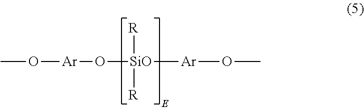

wherein E and R are as defined in formula (4); each R can be the same or different, and is as defined above; and Ar can be the same or different, and is a substituted or unsubstituted C₆₋₃₀ arylene, wherein the bonds are directly connected to an aromatic moiety. Ar groups in formula (5) can be derived from a C₆₋₃₀ dihydroxyarylene compound. Dihydroxyarylene compounds are 1,1-bis(4-hydroxyphenyl) methane, 1,1-bis(4-hydroxyphenyl) ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl)cyclohexane, bis(4-hydroxyphenyl sulfide), and 1,1-bis(4-hydroxy-t-butylphenyl) propane.

In another aspect, polysiloxane blocks are of formula (6)

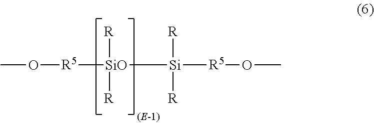

wherein R and E are as described above, and each R⁵ is independently a divalent C₁₋₃₀ organic group, and wherein the polymerized polysiloxane unit is the reaction residue of its corresponding dihydroxy compound. In a specific aspect, the polysiloxane blocks are of formula (7):

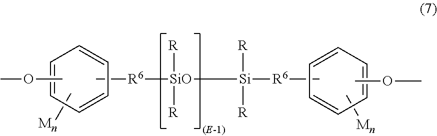

wherein R and E are as defined above. R⁶ in formula (7) is a divalent C₂₋₈ aliphatic group. Each M in formula (7) can be the same or different, and can be a halogen, cyano, nitro, C₁₋₈ alkylthio, C₁₋₈ alkyl, C₁₋₈ alkoxy, C₂₋₈ alkenyl, C₂₋₈ alkenyloxy, C₃₋₈ cycloalkyl, C₃₋₈ cycloalkoxy, C₆₋₁₀ aryl, C₆₋₁₀ aryloxy, C₇₋₁₂ aralkyl, C₇₋₁₂ aralkoxy, C₇₋₁₂ alkylaryl, or C₇₋₁₂ alkylaryloxy, wherein each n is independently 0, 1, 2, 3, or 4.

In an aspect, M is bromo or chloro, an alkyl such as methyl, ethyl, or propyl, an alkoxy such as methoxy, ethoxy, or propoxy, or an aryl such as phenyl, chlorophenyl, or tolyl; R⁶ is a dimethylene, trimethylene or tetramethylene; and R is a C₁₋₈ alkyl, haloalkyl such as trifluoropropyl, cyanoalkyl, or aryl such as phenyl, chlorophenyl or tolyl. In another aspect, Ris methyl, or a combination of methyl and trifluoropropyl, or a combination of methyl and phenyl. In still another aspect, R is methyl, M is methoxy, n is one, and R⁶ is a divalent C₁₋₃ aliphatic group. Specific polysiloxane blocks are of the formula

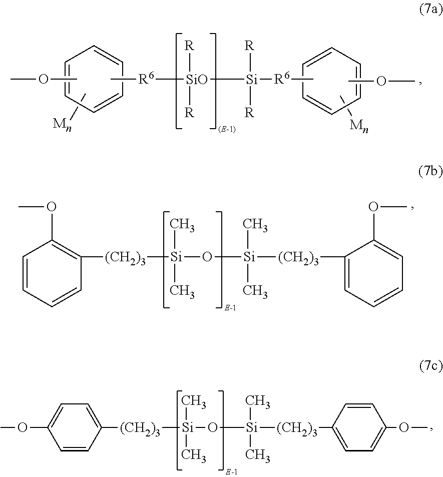

or a combination thereof, wherein E has an average value of 2 to 200, 2 to 125, 5 to 125, 5 to 100, 5 to 50, 20 to 80, or 5 to 20.

Blocks of formula (7) can be derived from the corresponding dihydroxy polysiloxane, which in turn can be prepared effecting a platinum-catalyzed addition between the siloxane hydride and an aliphatically unsaturated monohydric phenol such as eugenol, 2-alkylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. The poly(carbonate-siloxane) copolymers can then be manufactured, for example, by the synthetic procedure of European Patent Application Publication No. 0 524 731 Al of Hoover, page 5, Preparation 2.

The poly(carbonate-siloxane) copolymers can comprise 50 to 95 weight percent of carbonate units and 5 to 50 weight percent siloxane units. Within this range, the poly(carbonate-siloxane) copolymer can comprise 50 to 85 weight percent, more preferably 60 to 80 weight percent of carbonate units and 15 to 50 weight percent, more preferably 20 to 40 weight percent siloxane units.

Suitable polycarbonate-siloxane copolymers can include, for example, those commercially available under the trade name EXL from SABIC.

In an aspect, the polycarbonate component can comprise the branched polycarbonate. Specifically, in an aspect, the polycarbonate component can be a branched polycarbonate comprising units as described above; greater than or equal to 3 mole %, based on the total moles of the polycarbonate, of moieties derived from a branching agent; and end-capping groups derived from an end-capping agent having a pKa between 8.3 and 11. The branching agent can comprise trimellitic trichloride, 1,1,1-tris(4-hydroxyphenyl) ethane or a combination of trimellitic trichloride and 1,1,1-tris(4-hydroxyphenyl) ethane, and the end-capping agent is phenol or a phenol containing a substituent of cyano group, aliphatic groups, olefinic groups, aromatic groups, halogens, ester groups, ether groups, or a combination thereof. In a specific aspect, the end-capping agent is phenol, p-t-butylphenol, p-methoxyphenol, p-cyanophenol, p-cumylphenol, or a combination thereof. In an aspect, the end capping agent is cyanophenol.

In an aspect, the polycarbonate component can comprise a copolycarbonate comprising repeating units derived from bisphenol A and bulky bisphenol carbonate units, i.e., derived from bisphenols containing at least 18 carbon atoms, for example 18 to 60 carbon atoms or 20 to 40 carbon atoms. Exemplary bulky bisphenol carbonate units can include, for example, bulky bisphenol carbonate groups of formulas (8) to (14)

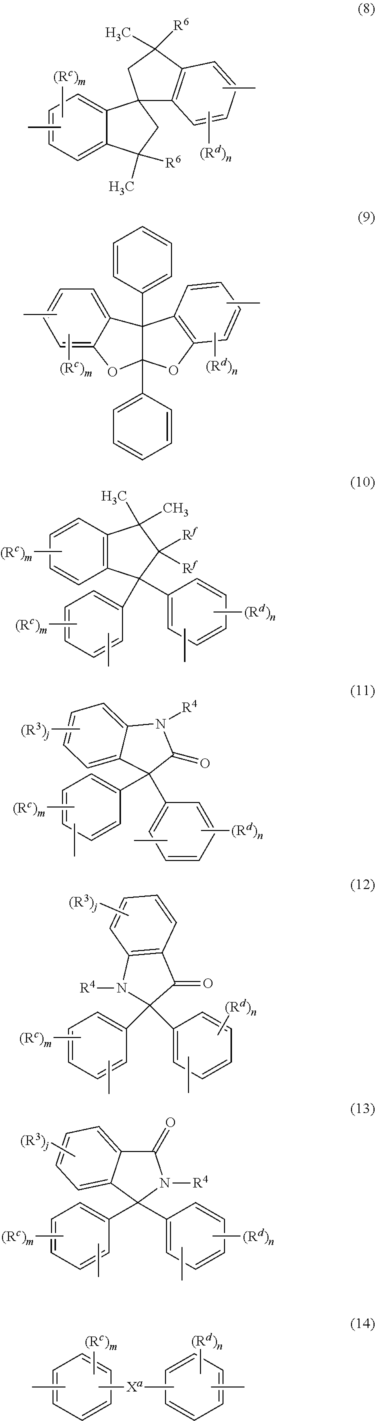

wherein R^{c} and R^{d} are each independently a C₁₋₁₂ alkyl, C₂₋₁₂ alkenyl, C₃₋₈ cycloalkyl, or C₁₋₁₂ alkoxy, each R^{f} is hydrogen or both R_{f} together are a carbonyl group, each R³ is independently C₁₋₆ alkyl, R⁴ is hydrogen, C₁₋₆ alkyl, or phenyl optionally substituted with 1 to 5 C₁₋₆ alkyl groups, R⁶ is independently C₁₋₃ alkyl, or phenyl, preferably methyl, X^{a} is a C₆₋₁₂ polycyclic aryl, C₃₋₁₈ mono- or polycycloalkylene, C₃₋₁₈ mono- or polycycloalkylidene, —C(R^{f})(R^{g})— wherein R^{f} is hydrogen, C₁₋₁₂ alkyl, or C₆₋₁₂ aryl and R^{g} is C₆₋₁₀ alkyl, C₆₋₈ cycloalkyl, or C₆₋₁₂ aryl, or —(Q¹)ₓ-G-(Q¹)_{y}-group, wherein Q¹ and Q² are each independently a C₁₋₃ alkylene, G is a C₃₋₁₀ cycloalkylene, x is 0 or 1, and y is 0 or 1, and j, m, and n are each independently 0 to 4. A combination of high heat bisphenol groups can be used.

In an aspect, R^{c} and R^{d} are each independently a C₁₋₃ alkyl, or C₁₋₃ alkoxy, each R⁶ is methyl, each R³ is independently C₁₋₃ alkyl, R⁴ is methyl, or phenyl, each R⁶ is independently C₁₋₃ alkyl, or phenyl, preferably methyl, X^{a} is a C₆₋₁₂ polycyclic aryl, C₃₋₁₈ mono-or polycycloalkylene, C₃₋₁₈ mono- or polycycloalkylidene, —C(R^{f})(R^{g})— wherein R^{f} is hydrogen, C₁₋₁₂ alkyl, or C₆₋₁₂ aryl and R^{g} is C₆₋₁₀ alkyl, C₆₋₈ cycloalkyl, or C₆₋₁₂ aryl, or —(Q¹)ₓ-G-(Q²)_{y}—group, wherein Q¹ and Q² are each independently a C₁₋₃ alkylene and G is a C₃₋₁₀ cycloalkylene, x is 0 or 1, and y is 0 or 1, and j, m, and n are each independently 0 or 1.

Exemplary bulky bisphenol groups can include those of formulas (13a) and (14a) to (14k)

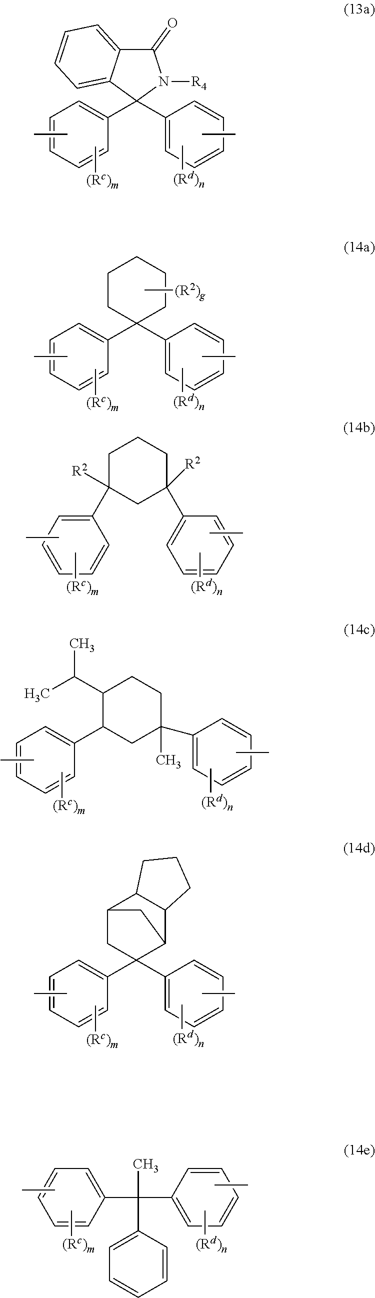

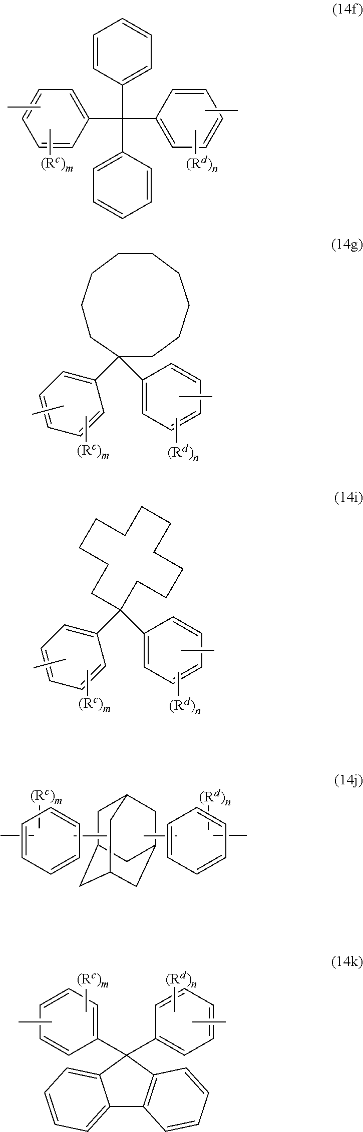

wherein R^{c} and R^{d} are the same as defined for formulas (8) to (14), each R² is independently C₁₋₄ alkyl, m and n are each independently 0 to 4, each R³ is independently C₁₋₄ alkyl or hydrogen, R⁴ is C₁₋₆ alkyl or phenyl optionally substituted with 1 to 5 C₁₋₆ alkyl groups, and g is 0 to 10. In a specific aspect each bond of the bisphenol group is located para to the linking group that is X^{a}. In an aspect, R^{c} and R^{d} are each independently a C₁₋₃ alkyl, or C₁₋₃ alkoxy, each R² is methyl, x is 0 or 1, y is 1, and m and n are each independently 0 or 1.

The bulky bisphenol group is preferably of formula (13a-2) or (14a-2)

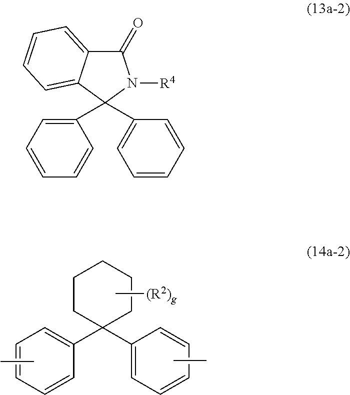

wherein R⁴ is methyl or phenyl, each R² is methyl, and g is 1 to 4. Preferably, the bulky bisphenol group is derived from 2-phenyl-3,3′-bis(4-hydroxyphenyl) phthalimidine (PPPBP) or from 1,1-bis(4-hydroxyphenyl)-3,3,5-trimethyl-cyclohexane (BP-TMC).

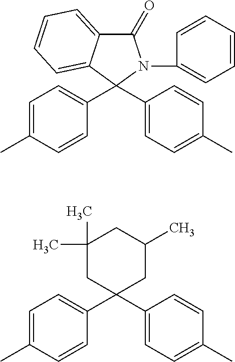

In an aspect, such a copolycarbonate can include copolycarbonates comprising bisphenol A carbonate units and 2-phenyl-3,3′-bis(4-hydroxyphenyl) phthalimidine carbonate units (a BPA-PPPBP copolymer, commercially available under the trade name XHT and CXT from SABIC), a copolymer comprising bisphenol A carbonate units and 1,1-bis(4-hydroxy-3-methylphenyl)cyclohexane carbonate units (a BPA-DMBPC copolymer commercially available under the trade name DMC from SABIC), and a copolymer comprising bisphenol A carbonate units and isophorone bisphenol carbonate units (available, for example, under the trade name APEC from Bayer). In an aspect, the polycarbonate component can comprise a BPA-PPPBP copolymer.

In an aspect, the composition can comprise a polycarbonate-ester, for example poly(aromatic ester-carbonate) s comprising bisphenol A carbonate units and isophthalate-terephthalate-bisphenol A ester units, also commonly referred to as poly(carbonate-ester) s (PCE) or poly(phthalate-carbonate) s (PPC), depending on the relative ratio of carbonate units and ester units. Another specific poly(ester-carbonate) comprises resorcinol isophthalate and terephthalate units and bisphenol A carbonate units, such as those commercially available under the trade name LEXAN SLX from SABIC.

For example, in a specific aspect, the polyester-carbonate comprises, in addition to recurring carbonate units of formula (1), repeating ester units of formula (15)

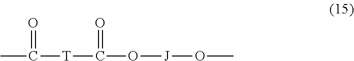

wherein J is a divalent group derived from an aromatic dihydroxy compound (including a reactive derivative thereof), such as a bisphenol of formula (3), e.g., bisphenol A; and T is a divalent group derived from an aromatic dicarboxylic acid (including a reactive derivative thereof), preferably isophthalic or terephthalic acid wherein the weight ratio of isophthalic acid to terephthalic acid is 91:9 to 2:98. Copolyesters containing a combination of different T or J groups can be used. The polyester units can be branched or linear.

In an aspect, J is derived from a bisphenol of formula (3), e.g., bisphenol A. In another aspect, J is derived from an aromatic dihydroxy compound, e.g., resorcinol. A portion of the groups J, for example up to 20 mole percent (mol %) can be a C₂₋₃₀ alkylene group having a straight chain, branched chain, or cyclic (including polycyclic) structure, for example ethylene, n-propylene, i-proplyene, 1,4-butylene, 1,4-cyclohexylene, or 1,4-methylenecyclohexane. Preferably, all J groups are aromatic.

Aromatic dicarboxylic acids that can be used to prepare the polyester units include isophthalic or terephthalic acid, 1,2-di(p-carboxyphenyl) ethane, 4,4′-dicarboxydiphenyl ether, 4,4′-bisbenzoic acid, or a combination thereof. Acids containing fused rings can also be present, such as in 1,4-, 1,5-, or 2,6-naphthalenedicarboxylic acids. Specific dicarboxylic acids include terephthalic acid, isophthalic acid, naphthalene dicarboxylic acid, or a combination thereof. A specific dicarboxylic acid comprises a combination of isophthalic acid and terephthalic acid wherein the weight ratio of isophthalic acid to terephthalic acid is 91:9 to 2:98. A portion of the groups T, for example up to 20 mol %, can be aliphatic, for example derived from 1,4-cyclohexane dicarboxylic acid. Preferably all T groups are aromatic.

The molar ratio of ester units to carbonate units in the polycarbonates can vary broadly, for example 1:99 to 99:1, preferably 10:90 to 90:10, more preferably 25:75 to 75:25, or 2:98 to 15:85, depending on the desired properties of the final composition.

Specific poly(ester-carbonate) s are those including bisphenol A carbonate units and isophthalate/terephthalate-bisphenol A ester units, i.e., a poly(bisphenol A carbonate)-co-(bisphenol A-phthalate-ester) of formula (15a)

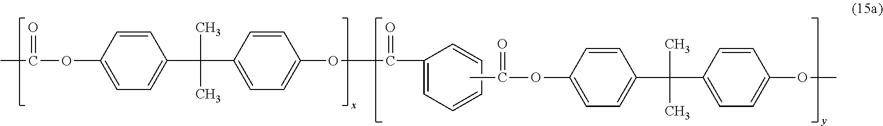

wherein x and y represent the weight percent of bisphenol A carbonate units and isophthalate/terephthalate-bisphenol A ester units, respectively. Generally, the units are present as blocks. In an aspect, the weight ratio of carbonate units x to ester units y in the polycarbonates is 1:99 to 50:50, or 5:95 to 25:75, or 10:90 to 45:55. Copolymers of formula (15) comprising 35-45 wt % of carbonate units and 55-65 wt % of ester units, wherein the ester units have a molar ratio of isophthalate to terephthalate of 45:55 to 55:45 are often referred to as poly(carbonate-ester) s (PCE). Copolymers comprising 15-25 wt % of carbonate units and 75-85 wt % of ester units, wherein the ester units have a molar ratio of isophthalate to terephthalate from 98:2 to 88:12 are often referred to as poly(phthalate-carbonate) s (PPC).

In another aspect, the high heat poly(ester-carbonate) is a poly(carbonate-co-monoarylate ester) of formula (15b) that includes aromatic carbonate units (1) and repeating monoarylate ester units

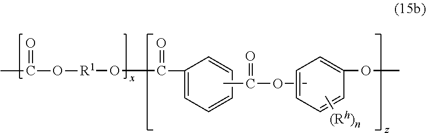

wherein R¹ is as defined in formula (1), and each R^{h} is independently a halogen atom, a C₁₋₁₀ hydrocarbyl such as a C₁₋₁₀ alkyl group, a halogen-substituted C₁₋₁₀ alkyl group, a C₆₋₁₀ aryl group, or a halogen-substituted C₆₋₁₀ aryl group, and n is 0-4. Preferably, each Rhis independently a C₁₋₄ alkyl, and n is 0-3, 0-1, or 0. The mole ratio of carbonate units x to ester units z can be from 99:1 to 1:99, or from 98:2 to 2:98, or from 90:10 to 10:90. In an aspect the mole ratio of x: z is from 50:50 to 99:1, or from 1:99 to 50:50.

In an aspect, the high heat poly(ester-carbonate) comprises aromatic ester units and monoarylate ester units derived from the reaction of a combination of isophthalic and terephthalic diacids (or a reactive derivative thereof) with resorcinol (or a reactive derivative thereof) to provide isophthalate/terephthalate-resorcinol (“ITR” ester units). The ITR ester units can be present in the high heat poly(ester-carbonate) in an amount greater than or equal to 95 mol %, preferably greater than or equal to 99 mol %, and still more preferably greater than or equal to 99.5 mol %, based on the total moles of ester units in the polycarbonate. A preferred high heat poly(ester-carbonate) comprises bisphenol A carbonate units, and ITR ester units derived from terephthalic acid, isophthalic acid, and resorcinol, i.e., a poly(bisphenol A carbonate-co-isophthalate/terephthalate-resorcinol ester) of formula (15c)

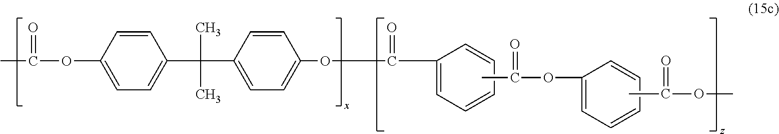

wherein the mole ratio of x: z is from 98:2 to 2:98, or from 90:10 to 10:90. In an aspect the mole ratio of x: z is from 50:50 to 99:1, or from 1:99 to 50:50. The ITR ester units can be present in the poly(bisphenol A carbonate-co-isophthalate-terephthalate-resorcinol ester) in an amount greater than or equal to 95 mol %, preferably greater than or equal to 99 mol %, and still more preferably greater than or equal to 99.5 mol %, based on the total moles of ester units in the copolymer. Other carbonate units, other ester units, or a combination thereof can be present, in a total amount of 1 to 20 mole %, based on the total moles of units in the copolymers, for example monoaryl carbonate units of formula (16) and bisphenol ester units of formula (17):

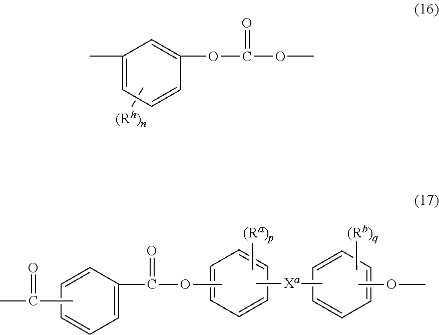

wherein, in the foregoing formulae, R^{h} is each independently a C₁₋₁₀ hydrocarbon group, n is 0-4, R^{a} and R^{b} are each independently a C₁₋₁₂ alkyl, p and q are each independently integers of 0-4, and X^{a} is a single bond, —O—, —S—, —S(O)—, —S(O)₂—, —C(O)—, or a C₁₋₁₃ alkylidene of formula-C(R^{c})(R^{d})— wherein R^{c} and R^{d} are each independently hydrogen or C₁₋₁₂ alkyl, or a group of the formula —C(═R^{c})— wherein R^{c} is a divalent C₁₋₁₂ hydrocarbon group. The bisphenol ester units can be bisphenol A phthalate ester units of the formula (17b)

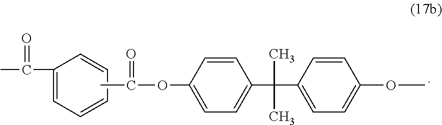

In an aspect, the poly(bisphenol A carbonate-co-isophthalate/terephthalate-resorcinol ester) (15c) comprises 1-90 mol % of bisphenol A carbonate units, 10-99 mol % of isophthalic acid-terephthalic acid-resorcinol ester units, and optionally 1-60 mol % of resorcinol carbonate units, isophthalic acid-terephthalic acid-bisphenol A phthalate ester units, or a combination thereof. In another aspect, poly(bisphenol A carbonate-co-isophthalate/terephthalate resorcinol ester) comprises 10-20 mol % of bisphenol A carbonate units, 20-98 mol % of isophthalic acid-terephthalic acid-resorcinol ester units, and optionally 1-60 mol % of resorcinol carbonate units, isophthalic acid-terephthalic acid-bisphenol A phthalate ester units, or a combination thereof.

The high heat poly(ester-carbonate) s can have a weight average molecular weight (Mw) of 2,000-100,000 g/mol, preferably 3,000-75,000 g/mol, more preferably 4,000-50,000 g/mol, more preferably 5,000-35,000 g/mol, and still more preferably 17,000-30,000 g/mol. Molecular weight determinations are performed using GPC using a cross linked styrene-divinyl benzene column, at a sample concentration of 1 milligram per milliliter, and as calibrated with bisphenol A homopolycarbonate standards. Samples are eluted at a flow rate of 1.0 ml/min with methylene chloride as the eluent.

The polycarbonate component (i.e., the polycarbonate-siloxane copolymer, the polycarbonate ester, the branched polycarbonate, or the copolycarbonate comprising a bulky bisphenol group) can be present in the composition in an amount of 5 to 70 weight percent, based on the total weight of the composition. Within this range, the polycarbonate component can be present in the composition in an amount of at least 9 weight percent, or at least 10 weight percent, or at least 15 weight percent, or at least 25 weight percent, or at least 40 percent, or at least 50 weight percent. Also within this range, the polycarbonate component can be present in the composition in an amount of at most 65 weight percent, or at most 60 weight percent, or at most 55 weight percent, or at most 50 weight percent. In an aspect, the polycarbonate component can be present in an amount of 5 to 35 weight percent, or 10 to 25 weight percent, or 10 to 30 weight percent, or 35 to 55 weight percent. Combinations of any of the foregoing upper and lower limits are also contemplated.

When the composition comprises the polycarbonate-siloxane copolymer, the branched polycarbonate, or the copolycarbonate comprising bulky bisphenol carbonate repeating units, the composition further comprises a linear polycarbonate, preferably a linear homopolycarbonate. The linear polycarbonate, when present in the composition with the polycarbonate-siloxane copolymer, the branched polycarbonate, or the copolycarbonate comprising phthalimidine carbonate repeating units, is a combination of at least two polycarbonates having particular melt flow rates. For example, the linear polycarbonate homopolymer comprises at least two of an ultra high flow polycarbonate having a melt flow rate of 55 to 85 g/10 minutes, as determined according to ASTM D1238 at 300° C. and 1.2 kg; a high flow polycarbonate having a melt flow rate of greater than 20 to 54 g/10 minutes or 20 to 50 g/10 minutes, as determined according to ASTM D1238 at 300° C. and 1.2 kg; a low flow polycarbonate having a melt flow rate of 5 to 19 g/10 minutes or 5 to 10 g/10 minutes, as determined according to ASTM D1238 at 300° C. and 1.2 kg; and an ultra-low flow polycarbonate having a melt flow rate of less than 5 g/10 minutes, as determined according to ASTM D1238 at 300° C. and 1.2 kg. The at least two linear polycarbonate homopolymer are preferably selected from differing flow rate categories set forth above. For example, the composition does not include two linear polycarbonate homopolymers that are both high flow (i.e., both within the range of greater than 20 to 54 g/10 minutes).

When the composition comprises the polyester-carbonate, one or more of the foregoing linear polycarbonate components may or may not be present. When included with the polyester-carbonate, a single linear homopolycarbonate or a combination of two or more may be used. The linear polycarbonate can be as described above.

The linear polycarbonates can also be characterized in terms of their molecular weight, which are in the range of 10,000 and 100,000 g/mol. For example, a high flow polycarbonate can have a weight average molecular weight of less than 25,000 grams per mole. A low flow polycarbonate can have a weight average molecular weight of 25,000 to 35,000 grams per mole. An ultra-low flow polycarbonate can have a weight average molecular weight of greater than 35,000 grams per mole. Molecular weight can be determined using gel permeation chromatography (GPC) relative to linear bisphenol A polycarbonate standards.

The linear polycarbonates, when present, are preferably virgin polycarbonates.

The linear polycarbonate can be as described above, for example comprising repeating units according to formula (1). An exemplary linear homopolymer containing bisphenol A carbonate units (BPA-PC) is commercially available under the trade name LEXAN from SABIC.

When present, the composition can comprise the linear polycarbonate homopolymer in an amount of 5 to 65 weight percent, based on the total weight of the composition. Within this range, the composition can comprise the polycarbonate in an amount of at least 10 weight percent, or at least 12 weight percent, or at least 15 weight percent. Also within this range, the composition can comprise the polycarbonate in an amount of at most 45 weight percent, or at most 40 weight percent, or at most 35 weight percent, or at most 30 weight percent, or at most 25 weight percent, or at most 20 weight percent.

In an aspect, the composition can comprise 25 to 90 weight percent of the post-consumer recycle polycarbonate; 5 to 70 weight percent of the polycarbonate-siloxane copolymer, or the branched polycarbonate, or the copolycarbonate comprising repeating units derived from a bulky bisphenol group; and 5 to 65 weight percent of the linear polycarbonate homopolymer comprising at least two of an ultra high flow polycarbonate having a melt flow rate of 55 to 85 g/10 minutes, as determined according to ASTM D1238 at 300° C. and 1.2 kg; a high flow polycarbonate having a melt flow rate of greater than 20 to 54 g/10 minutes, as determined according to ASTM D1238 at 300° C. and 1.2 kg; a low flow polycarbonate having a melt flow rate of 5 to 19 g/10 minutes, as determined according to ASTM D1238 at 300° C. and 1.2 kg; and an ultra-low flow polycarbonate having a melt flow rate of less than 5 g/10 minutes, as determined according to ASTM D1238 at 300° C. and 1.2 kg.

Various combinations of the aforementioned linear homopolycarbonates having different melt flow rates are contemplated herein. For example, the linear polycarbonate homopolymer can comprise the high flow polycarbonate and the low flow polycarbonate, the low flow polycarbonate and the ultra low flow polycarbonate, or the low flow polycarbonate and the ultra high flow polycarbonate.

In an aspect, the composition can comprise 5 to 35 weight percent of the high flow polycarbonate; and 4 to 10 weight percent of the low flow polycarbonate. In an aspect, the composition can comprise 1 to 10 weight percent of the low flow polycarbonate and 8 to 15 weight percent of the ultra-low flow polycarbonate. In an aspect, the composition can comprise 8 to 22 weight percent of the low flow polycarbonate and 20 to 35 weight percent of the ultra high flow polycarbonate.

In an aspect, when the composition comprises the polycarbonate-siloxane copolymer, the linear polycarbonate homopolymer can comprise the high flow polycarbonate and the low flow polycarbonate or the low flow polycarbonate and the ultra low flow polycarbonate. In an aspect, when the composition comprises the copolycarbonate comprising repeating units derived from a bulky bisphenol group (e.g., a phthalimidine group), the linear polycarbonate homopolymer can comprise the low flow polycarbonate and the ultra high flow polycarbonate. In an aspect, when the composition comprises the branched polycarbonate, the linear polycarbonate homopolymer can comprise the high flow polycarbonate and the low flow polycarbonate.

In a specific aspect, the composition can comprise 45 to 90 weight percent of the post-consumer recycle polycarbonate; 5 to 35 weight percent of the polycarbonate-siloxane copolymer, and 5 to 40 weight percent of a linear polycarbonate homopolymer comprising the high flow polycarbonate and the low flow polycarbonate; or the low flow polycarbonate and the ultra-low flow polycarbonate.

In another specific aspect, the composition can comprise 25 to 55 weight percent of the post-consumer recycle polycarbonate; 10 to 25 weight percent of the copolycarbonate comprising phthalimidine carbonate repeating units, and 30 to 55 weight percent of a linear polycarbonate homopolymer comprising the low flow polycarbonate and the ultra-high flow polycarbonate.

In another specific aspect, the composition can comprise 40 to 60 weight percent of the post-consumer recycle polycarbonate; 10 to 30 weight percent of the branched polycarbonate comprising a cyanophenol end group, and 10 to 30 weight percent of a linear polycarbonate homopolymer comprising the low flow polycarbonate and the high flow polycarbonate.

In another specific aspect, the composition can comprise 20 to 60 weight percent of the post-consumer recycle polycarbonate; 35 to 55 weight percent of the polycarbonate-ester; and optionally, 15 to 35 weight percent of the high flow polycarbonate.

The thermoplastic composition can optionally further comprise various additives ordinarily incorporated into polycarbonate compositions, with the proviso that the additive(s) are selected so as to not significantly adversely affect the desired properties of the polycarbonate composition, in particular the color of the composition. Such additives can be mixed at a suitable mixing time during the mixing of the components for forming the composition. Additives can include, for example, impact modifiers, fillers, reinforcing agents, antioxidants, heat stabilizers, light stabilizers, ultraviolet (UV) light stabilizers, plasticizers, lubricants, mold release agents, antistatic agents, colorants such as such as titanium dioxide, carbon black, and organic dyes, surface effect additives, radiation stabilizers, flame retardants, and anti-drip agents. A combination of additives can be used, for example a combination of a stabilizer (e.g., a heat stabilizer), a flame retardant, and a color package. In general, the additives can be used in the amounts generally known to be effective. For example, the total amount of the additives (other than any impact modifier, filler, or reinforcing agent) can be 0.001 to 10.0 wt %, or 0.01 to 5 wt %, each based on the total weight of the polymer in the composition.

In an aspect, the composition can optionally further comprise a flame retardant. Useful flame retardants can include organic compounds that include phosphorus, bromine, or chlorine. Non-brominated and non-chlorinated phosphorus-containing flame retardants can be preferred in certain applications for regulatory reasons, for example organic phosphates and organic compounds containing phosphorus-nitrogen bonds.

Flame retardant aromatic phosphates include triphenyl phosphate, tricresyl phosphate, isopropylated triphenyl phosphate, phenyl bis(dodecyl) phosphate, phenyl bis(neopentyl) phosphate, phenyl bis(3,5,5′-trimethylhexyl) phosphate, ethyl diphenyl phosphate, 2-ethylhexyl di(p-tolyl) phosphate, bis(2-ethylhexyl) p-tolyl phosphate, tritolyl phosphate, bis(2-ethylhexyl) phenyl phosphate, tri (nonylphenyl) phosphate, bis(dodecyl) p-tolyl phosphate, dibutyl phenyl phosphate, 2-chloroethyl diphenyl phosphate, p-tolyl bis(2,5,5′-trimethylhexyl) phosphate, and 2-ethylhexyl diphenyl phosphate. Di-or polyfunctional aromatic phosphorus-containing compounds are also useful, for example resorcinol tetraphenyl diphosphate (RDP), the bis(diphenyl) phosphate of hydroquinone and the bis(diphenyl) phosphate of bisphenol A, respectively, and their oligomeric and polymeric counterparts.

Flame retardant compounds containing phosphorus-nitrogen bonds include phosphazenes, phosphonitrilic chloride, phosphorus ester amides, phosphoric acid amides, phosphonic acid amides, phosphinic acid amides, and tris(aziridinyl) phosphine oxide. These flame-retardant additives are commercially available. In an aspect, the organophosphorus flame retardant containing a phosphorus-nitrogen bond is a phosphazene or cyclic phosphazene of the formulas

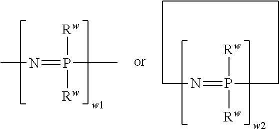

wherein w1 is 3 to 10,000; w2 is 3 to 25, or 3 to 7; and each R^{w} is independently a C₁₋₁₂ alkyl, alkenyl, alkoxy, aryl, aryloxy, or polyoxyalkylene group. In the foregoing groups at least one hydrogen atom of these groups can be substituted with a group having an N, S, O, or F atom, or an amino group. For example, each R^{w} can be a substituted or unsubstituted phenoxy, an amino, or a polyoxyalkylene group. Any given R^{w} can further be a crosslink to another phosphazene group. Exemplary crosslinks include bisphenol groups, for example bisphenol A groups. Examples include phenoxy cyclotriphosphazene, octaphenoxy cyclotetraphosphazene decaphenoxy cyclopentaphosphazene, and the like. In an aspect, the phosphazene has a structure represented by the formula

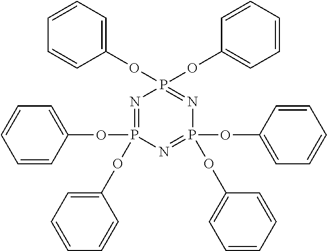 [SMILES: c1ccc(OP2(Oc3ccccc3)=NP(Oc3ccccc3)(Oc3ccccc3)=NP(Oc3ccccc3)(Oc3ccccc3)=N2)cc1]

Commercially available phenoxyphosphazenes having the aforementioned structures are LY202 manufactured and distributed by Lanyin Chemical Co., Ltd, FP-110 manufactured and distributed by Fushimi Pharmaceutical Co., Ltd, and SPB-100 manufactured and distributed by Otsuka Chemical Co., Ltd.

Halogenated materials can also be used as flame retardants, for example bisphenols of which the following are representative: 2,2-bis-(3,5-dichlorophenyl)-propane; bis-(2-chlorophenyl)-methane; bis(2,6-dibromophenyl)-methane; 1,1-bis-(4-iodophenyl)-cthane; 1,2-bis-(2,6-dichlorophenyl)-ethane; 1,1-bis-(2-chloro-4-iodophenyl) ethane; 1,1-bis-(2-chloro-4-methylphenyl)-ethane; 1,1-bis-(3,5-dichlorophenyl)-ethane; 2,2-bis-(3-phenyl-4-bromophenyl)-ethane: 2,6-bis-(4,6-dichloronaphthyl)-propane; and 2,2-bis-(3,5-dichloro-4-hydroxyphenyl)-propane 2,2 bis-(3-bromo-4-hydroxyphenyl)-propane. Other halogenated materials include 1,3-dichlorobenzene, 1,4-dibromobenzene, 1,3-dichloro-4-hydroxybenzene, and biphenyls such as 2,2′-dichlorobiphenyl, polybrominated 1,4-diphenoxybenzene, 2,4′-dibromobiphenyl, and 2,4′-dichlorobiphenyl as well as decabromo diphenyl oxide, as well as oligomeric and polymeric halogenated aromatic compounds, such as a copolycarbonate of bisphenol A and tetrabromobisphenol A and a carbonate precursor, e.g., phosgene. Metal synergists, e.g., antimony oxide, can also be used with the flame retardant.

Alternatively, the thermoplastic composition can be essentially free of chlorine and bromine. “Essentially free of chlorine and bromine” is defined as having a bromine or chlorine content of less than or equal to 100 parts per million by weight (ppm), less than or equal to 75 ppm, or less than or equal to 50 ppm, based on the total parts by weight of the composition.

Inorganic flame retardants can also be used, for example salts of C₁₋₁₆ alkyl sulfonate salts such as potassium perfluorobutane sulfonate (Rimar salt), potassium perfluoroctane sulfonate, tetraethylammonium perfluorohexane sulfonate, and potassium diphenylsulfone sulfonate; salts such as Na₂CO₃, K₂CO₃, MgCO₃, CaCO₃, and BaCO₃, or fluoro-anion complexes such as LisAlF₆, BaSiF₆, KBF₄, K₃AlF₆, KAlF₄, K₂SiF₆, or Na₃AlF₆.

When present, the flame retardant can be included in the composition in an amount of 0.01 to 10 weight percent. Within this range, the flame retardant can be present in an amount of 0.1 to 10 weight percent, or 1 to 10 weight percent, or 1 to 8 weight percent, or 2 to 6 weight percent, or 3 to 5 weight percent, each based on the total weight of the composition.

Heat stabilizer additives can include organophosphites (e.g. triphenyl phosphite, tris-(2,6-dimethylphenyl) phosphite, tris-(mixed mono- and di-nonylphenyl) phosphite or the like), phosphonates (e.g., dimethylbenzene phosphonate or the like), phosphates (e.g., trimethyl phosphate, or the like), or a combination thereof. The heat stabilizer can be tris(2,4-di-t-butylphenyl) phosphate available as IRGAPHOS 168. Heat stabilizers are generally used in amounts of 0.01 to 5 wt %, based on the total weight of polymer in the composition.

Light stabilizers or ultraviolet light (UV) absorbing additives, also referred to as UV stabilizers, can also be used. Light stabilizer additives include benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone, or the like, or a combination thereof.

UV absorbing additives include hydroxybenzophenones; hydroxybenzotriazoles; hydroxybenzotriazines; cyanoacrylates; oxanilides; benzoxazinones; aryl salicylates; monoesters of diphenols such as resorcinol monobenzoate; 2-(2H-benzotriazol-2-yl)-4-(1,1,3,3-tetramethylbutyl)-phenol (CYASORB 5411); 2-hydroxy-4-n-octyloxybenzophenone (CYASORB 531); 2-[4,6-bis(2,4-dimethylphenyl)-1,3,5-triazin-2-yl]-5-(octyloxy)-phenol (CYASORB 1164); 2,2′-(1,4-phenylene)bis(4H-3,1-benzoxazin-4-one) (CYASORB UV-3638); poly[(6-morphilino-s-triazine-2,4-diyl) [2,2,6,6-tetramethyl-4-piperidyl) imino]-hexamethylene[(2,2,6,6-tetramethyl-4-piperidyl) imino], 2-hydroxy-4-octyloxybenzophenone (UVINUL™3008), 6-tert-butyl-2-(5-chloro-2H-benzotriazole-2-yl)-4-methylphenyl (UVINUL™3026), 2,4-di-tert-butyl-6-(5-chloro-2H-benzotriazole-2-yl)-phenol (UVINUL™3027), 2-(2H-benzotriazole-2-yl)-4,6-di-tert-pentylphenol (UVINUL3028), 2-(2H-benzotriazole-2-yl)-4-(1,1,3,3-tetramethylbutyl)-phenol (UVINUL3029), 1,3-bis[(2′cyano-3′,3′-diphenylacryloyl)oxy]-2,2-bis-{[(2′-cyano-3′,3′-diphenylacryloyl)oxy]methyl}-propane (UVINUL3030), 2-(2H-benzotriazole-2-yl)-4-methylphenol (UVINUL3033), 2-(2H-benzotriazole-2-yl)-4,6-bis(1-methyl-1-phenyethyl) phenol (UVINUL3034), ethyl-2-cyano-3,3-diphenylacrylate (UVINUL3035), (2-ethylhexyl)-2-cyano-3,3-diphenylacrylate (UVINUL3039), N,N′-bisformyl-N,N′-bis(2,2,6,6-tetramethyl-4-piperidinyl) hexamethylendiamine (UVINUL4050H), bis-(2,2,6,6-tetramethyl-4-piperidyl)-sebacate (UVINUL4077H), bis-(1,2,2,6,6-pentamethyl-4-piperdiyl)-sebacate+methyl-(1,2,2,6,6-pentamethyl-4-piperidyl)-sebacate (UVINUL4092H) 1,3-bis[(2-cyano-3,3-diphenylacryloyl)oxy]-2,2-bis [[(2-cyano-3,3-diphenylacryloyl)oxy]methyl]propane (UVINUL 3030); 2,2′-(1,4-phenylene)bis(4H-3,1-benzoxazin-4-one); 1,3-bis[(2-cyano-3,3-diphenylacryloyl)oxy]-2,2-bis([(2-cyano-3,3-diphenylacryloyl)oxy]methyl|propane; TINUVIN 234; nano-size inorganic materials such as titanium oxide, cerium oxide, and zinc oxide, all with particle size less than or equal to 100 nanometers; or the like, or a combination thereof. UV absorbers can be used in amounts of 0.01 to 1 part by weight, based on 100 parts by weight of polycarbonate and impact modifier. UV absorbers that can be particularly useful with the polycarbonate compositions disclosed herein include 2-(2H-benzotriazol-2-yl)-4-(1,1,3,3-tetramethylbutyl)-phenol (e.g., CYASORB™ 5411 commercially available from Cytec Industries, Inc., Woodland Park, New Jersey) and 2,2′-(1,4-phenylene)bis(4H-3,1-benzoxazin-4-one) (e.g., CYASORB UV-3638, commercially available from Cytec Industries, Inc., Woodland Park, New Jersey), or a combination thereof. The UV stabilizers can be present in an amount of 0.01 to 1 wt %, preferably, 0.1 to 0.5 wt %, and more preferably, 0.15 to 0.4 wt %, based upon the total weight of the polycarbonate composition.

Plasticizers, lubricants, or mold release agents can also be used. There is considerable overlap among these types of materials, which include, for example, phthalic acid esters such as dioctyl-4,5-epoxy-hexahydrophthalate; tris-(octoxycarbonylethyl) isocyanurate; tristearin; di-or polyfunctional aromatic phosphates such as resorcinol tetraphenyl diphosphate (RDP), the bis(diphenyl) phosphate of hydroquinone and the bis(diphenyl) phosphate of bisphenol A; poly-alpha-olefins; epoxidized soybean oil; silicones, including silicone oils; esters, for example, fatty acid esters such as alkyl stearyl esters, e.g., methyl stearate, stearyl stearate, pentaerythritol tetrastearate, and the like; combinations of methyl stearate and hydrophilic and hydrophobic nonionic surfactants comprising polyethylene glycol polymers, polypropylene glycol polymers, poly(ethylene glycol-co-propylene glycol) copolymers, or a combination thereof, e.g., methyl stearate and polyethylene-polypropylene glycol copolymer in a suitable solvent; waxes such as beeswax, montan wax, paraffin wax, or the like.

The thermoplastic composition can optionally minimize or exclude various components not specifically provided for herein. For example, the composition can exclude a polymer other than the post-consumer recycle polycarbonate, the polycarbonate-siloxane copolymer, the polycarbonate-ester, the branched polycarbonate, the copolycarbonate comprising carbonate repeating units derived from a bulky bisphenol group, and the linear polycarbonate homopolymer. In an aspect, the composition can comprise less than 1 weight percent, or less than 0.5 weight percent, or less than 0.1 weight percent, or less than 0.01 weight percent of a laser direct structuring additive. In an aspect the composition can exclude a laser direct structuring additive.

A method for manufacturing the composition of the present disclosure is also provided. The thermoplastic compositions can be manufactured by various methods. For example, powdered polycarbonate, and other optional components can be first blended, optionally with any fillers, in a high-speed mixer or by hand mixing. The blend is then fed into the throat of a twin-screw extruder via a hopper. Alternatively, at least one of the components can be incorporated into the composition by feeding it directly into the extruder at the throat or downstream through a sidestuffer, or by being compounded into a masterbatch with a desired polymer and fed into the extruder. The extruder is generally operated at a temperature higher than that necessary to cause the composition to flow. The extrudate can be immediately quenched in a water bath and pelletized. The pellets so prepared can be one-fourth inch long or less as desired. Such pellets can be used for subsequent molding, shaping, or forming.

Shaped, formed, casted, or molded articles comprising the polycarbonate composition are also provided. The polycarbonate composition can be molded into useful shaped articles by a variety of methods, such as injection molding, extrusion, rotational molding, blow molding, and thermoforming. The article can be a molded article, a thermoformed article, an extruded film, an extruded sheet, a honeycomb structure, one or more layers of a multi-layer article, a substrate for a coated article, and a substrate for a metallized article. Exemplary articles can include computer and business machine housings such as housings for monitors, handheld electronic device housings such as housings for cell phones, electrical connectors, and components of lighting fixtures, ornaments, home appliances, roofs, greenhouses, sunrooms, swimming pool enclosures, electronic device casings and signs and the like. In addition, the polycarbonate compositions can be used for such applications as automotive panel and trim. Examples of suitable articles are exemplified by but are not limited to aircraft, automotive, truck, military vehicle (including automotive, aircraft, and water-borne vehicles), scooter, and motorcycle exterior and interior components, including panels, quarter panels, rocker panels, trim, fenders, doors, deck-lids, trunk lids, hoods, bonnets, roofs, bumpers, fascia, grilles, mirror housings, pillar appliqués, cladding, body side moldings, wheel covers, hubcaps, door handles, spoilers, window frames, beadlamp bezels, headlamps, tail lamps, tail lamp housings, tail lamp bezels, license plate enclosures, roof racks, and running boards; enclosures, housings, panels, and parts for outdoor vehicles and devices; enclosures for electrical and telecommunication devices; outdoor furniture; aircraft components; boats and marine equipment, including trim, enclosures, and housings; outboard motor housings; depth finder housings; personal water-craft; jet-skis; pools; spas; hot tubs; steps; step coverings; building and construction applications such as glazing, roofs, windows, floors, decorative window furnishings or treatments; treated glass covers for pictures, paintings, posters, and like display items; wall panels, and doors; counter tops; protected graphics; outdoor and indoor signs; enclosures, housings, panels, and parts for automatic teller machines (ATM); computer; desk-top computer; portable computer; lap-top computer; hand held computer housings; monitor; printer; keyboards; FAX machine; copier; telephone; phone bezels; mobile phone; radio sender; radio receiver; enclosures, housings, panels, and parts for lawn and garden tractors, lawn mowers, and tools, including lawn and garden tools; window and door trim; sports equipment and toys; enclosures, housings, panels, and parts for snowmobiles; recreational vehicle panels and components; playground equipment; shoe laces; articles made from plastic-wood combinations; golf course markers; utility pit covers; light fixtures; lighting appliances; network interface device housings; transformer housings; air conditioner housings; cladding or seating for public transportation; cladding or seating for trains, subways, or buses; meter housings; antenna housings; cladding for satellite dishes; coated helmets and personal protective equipment; coated synthetic or natural textiles; coated painted articles; coated dyed articles; coated fluorescent articles; coated foam articles; and like applications.

The composition of the present disclosure can be particularly useful in articles for consumer electronic applications. For example, the articles can be a component of a consumer electronic device such as a gaming console, a gaming controller, a portable gaming device, a cellular telephone, a television, a personal computer, a tablet computer, a laptop computer, a personal digital assistant, a portable media player, a digital camera, a portable music player, an appliance, a power tool, a robot, a toy, a greeting card, a home entertainment system, a loudspeaker, or a soundbar. In an aspect, the articles can be an electronic housing for an adapter, a cell phone, a smart phone, a GPS device, a laptop computer, a tablet computer, an e-reader, a copier, or a solar apparatus.

This disclosure is further illustrated by the following examples, which are non-limiting.

### EXAMPLES

Materials used in the following examples are described in Table 1.

TABLE 1

| Component | Description | Supplier |
|---|---|---|
| PCSi-1 | Bisphenol A polycarbonate-polydimethylsiloxane block copolymer | SABIC |
| | having a siloxane content of 6 weight percent, average PDMS block | |
| | length of 45 units, having a Mw of 22,000 to 24,000 grams per mole | |
| | as determined by gel permeation chromatography relative to linear | |
| | bisphenol A polycarbonate standards, produced by interfacial | |
| | polymerization and endcapped with p-cumylphenol | |
| PCSi-2 | Bisphenol A polycarbonate-polydimethylsiloxane block copolymer | SABIC |
| | having a siloxane content of 20 weight percent, average PDMS block | |
| | length of 45 units, having a Mw of 29,500 to 30,500 grams per mole | |
| | as determined by gel permeation chromatography relative to linear | |
| | bisphenol A polycarbonate standards, produced by interfacial | |
| | polymerization and endcapped with p-cumylphenol | |
| PCSi-3 | Polycarbonate-siloxane copolymer having a siloxane content of 40 | SABIC |
| | weight percent, average PDMS block length of 45 units, having a Mw | |
| | of 37,000 to 38,000 grams per mole as determined by gel permeation | |
| | chromatography relative to linear bisphenol A polycarbonate standards, | |
| | produced by interfacial polymerization and endcapped with p- | |
| | cumylphenol | |
| PCR-PC | Post-consumer recycle (PCR) bisphenol A polycarbonate having a melt | Ningbo XuRi |
| | flow rate of 12 to 16 g/10 mins (300 °C, 1.2 kg) and a light transmittance | Hong Yu |
| | of greater than 82% at a thickness of 3 mm, obtained as PC-116A | Technology |
| | | Co., Ltd |
| BPA-PC-1 | Cyanophenol end-capped bisphenol A homopolycarbonate produced via | SABIC |
| | interfacial polymerization, containing 3 mol % 1,1,1-tris(4- | |
| | hydroxyphenyl)ethane (THPE) branching agent | |
| PCE | Copolyester carbonate having 19 mole % resorcinol iso and tere (1:1) | SABIC |
| | phthalate ester linkages, 6 mol % resorcinol carbonate linkages and 75 | |
| | mole % BPA carbonate linkages, a Tg of 143 °C, and a Mw of 25,000- | |
| | 35,000 g/mol | |
| PPPBP-PC | Poly (N-phenylphenolphthaleinylbisphenol, 2,2-bis(4-hydro) carbonate- | SABIC |
| | co- bisphenol A carbonate), 35 mol % PPPBP units, Mw = 25,000 | |
| | g/mol determined via GPC using polystyrene standards, made by | |
| | interfacial polymerization, PCP end-capped, PDI = 2-3 | |
| HFPC | Linear bisphenol A polycarbonate having a Mw of 20,000-22,000 grams | SABIC |
| | per mole, as determined by gel permeation chromatography relative to | |
| | linear bisphenol A polycarbonate standards, produced by interfacial | |
| | polymerization, and having a melt flow rate of 25 to 30 g/10 mins | |
| | (ASTM D1238, 300 °C, 1.2 kg) | |
| LFPC | Linear bisphenol A polycarbonate, CAS Reg. No, 25971-63-5, having | SABIC |
| | a molecular weight (Mw) of 30,000-31,000 grams per mole, as | |
| | determined by gel permeation chromatography relative to linear | |
| | bisphenol A polycarbonate standards, produced by interfacial | |
| | polymerization, and having a melt flow rate of 6 to 8 g/10 mins | |
| | (ASTM D1238, 300 °C, 1.2 kg) | |
| ULFPC | Linear bisphenol A polycarbonate having a Mw of 36,000-37,000 | SABIC |
| | grams per mole, as determined by gel permeation chromatography | |
| | relative to linear bisphenol A polycarbonate standards, produced by | |
| | interfacial polymerization, and having a melt flow rate of 3 to 4 g/ | |
| | 10 mins (ASTM D1238, 300 °C, 1.2 kg) | |
| UHFPC | Linear bisphenol A polycarbonate having a Mw of 18,000-18,400 | SABIC |
| | grams per mole, as determined by gel permeation chromatography | |
| | relative to linear bisphenol A polycarbonate standards, produced by | |
| | interfacial polymerization, and having a melt flow rate of 60 to 80 g/ | |
| | 10 mins (ASTM D1238, 300 °C, 1.2 kg) | |
| BPA-PC-2 | Branched bisphenol A polycarbonate having a Mw of 38,000-39,500 | SABIC |
| | grams per mole, as determined by gel permeation chromatography | |
| | relative to linear bisphenol A polycarbonate standards | |
| TSAN | Poly(styrene-acrylonitrile)-encapsulated polytetrafluoroethylene, | SABIC |
| | containing 50 weight percent polytetrafluoroethylene; obtained as | |
| | INP449 | |
| FR-1 | Phenoxycyclophosphazene; obtained as RABITLE FP-110 | Fushimi |
| | | Pharmaceutical |
| | | Co., Ltd. |
| FR-2 | Potassium perfluorobutane sulfonate, CAS Reg. No. 29420-49-3; | 3M |
| | available as FR-2025 | |
| UVA-1 | 2- (2H-benzotriazol-2-yl)-4-(1,1,3,3-tetramethylbuty])-phenol, | Solvay |
| | obtained as CYASORB UV5411 | |
| UVA-2 | 2-[2-hydroxy-3,5-di-(1,1-dimethylbenzyl)]-2H-benzotriazol, | BASF |
| | obtained as TINUVIN 234 | |
| AO-1 | Tris(2,4-di-tert-butylphenyl) phosphite, CAS Reg. No. 31570-04-4; | BASF Corp. |
| | available as IRGAFOS 168 | |
| AO-2 | Bis(2,4-dicumylphenol)pentaerythritoldiphosphite, CAS Reg. No. | DOVER |
| | 154862-43-8; available as DOVERPHOS S-9228 | Chemical Corp. |
| AO-3 | Benzenepropanoic acid, 3, 5-bis(1, 1-dimethylethyl)-4-hydrox-, | BASF |
| | octadecyl ester, CAS Reg. No. 2082-79-3; available as IRGANOX 1076 | |
| AO-4 | Tetrakis(2,4-di-tert-butylphenyl)-4,4-biphenyldiphosphonite, , CAS | BASF |
| | Reg. No. 119345-01-6; available as IRGAFOS P-EPQ | |
| Epoxy | 7-oxabicyclo[4.1.0]heptane-3-carboxylic acid, 7- | Daicel |
| | oxabicyclo[4.1.0]hept-3-ylmethyl ester, CAS Reg. No. 2386-87-0; | |
| | available as CELLOXIDE 2021P | |
| Si oil-1 | High viscosity silicone oil, obtained as SFR-100 | Momentive |
| Si oil-2 | Dimethyl-diphenylpolysiloxane, CAS Reg. No. 68083-14-7; obtained as | Momentive |
| | TSF437 | |
| CycloSi | Octaphenylcyclotetrasiloxane, CAS Reg. No. 546-56-5; obtained as SX- | ShinEtsu |
| | 12-B | |
| PETS | Pentaerythritol tetrastearate | FACI |
| CB | Carbon black, CAS Reg. No. 1333-86-4; available as PRINTEX F80 | ORION |

The compositions of the following examples were prepared by blending the components together and extruding on a 25- or 37-mm twin-screw extruder. The compositions were subsequently injection molded. Temperature profiles for compounding and injection molding conditions are summarized Tables 2 and 3, respectively.

TABLE 2

| | | | PCE | PPPBP-PC |
|---|---|---|---|---|
| Parameters | Unit | Screw S-3-1B | Screw 2-lobs | Screw 2-lobs |
| Compounder Type | \ | W&P ZSK26Mc | W&P ZSK25 | ZSK25 |
| Feed (Zone 0) Temp | \ | 50 | 45 | 40 |
| Zone 1 Temp | °C | 100 | 200 | 200 |
| Zone 2 Temp | °C | 265 | 250 | 250 |
| Zone 3 Temp | °C | 265 | 270 | 270 |
| Zone 4 Temp | °C | 265 | 290 | 310 |
| Zone 5 Temp | °C | 265 | 290 | 310 |
| Zone 6 Temp | °C | 265 | 290 | 310 |
| Zone 7 Temp | °C | 265 | 290 | 310 |
| Zone 8 Temp | °C | 265 | | 310 |
| Zone 9 Temp | °C | 265 | | 310 |
| Zone 10 Temp | °C | 265 | | |
| Zone 11 Temp | °C | 265 | | |
| Die Temp | °C | 265 | 290 | 310 |

TABLE 3

| | | | PCE | PPPBP-PC |
|---|---|---|---|---|
| Molding parameters | unit | Value | Value | Value |
| Pre-drying time | Hour | 4 | 2-4 | 4 |
| Pre-drying temp | °C | 120 | 120 | 120 |
| Hopper temp | °C | 50 | 45 | 40 |
| Zone 1 temp | °C | 290 | 280 | 290 |
| Zone 2 temp | °C | 300 | 290 | 300 |
| Zone 3 temp | °C | 300 | 300 | 310 |
| Nozzle temp | °C | 300 | 295 | 305 |
| Mold temp | °C | 90 | 90 | 105 |

Physical measurements were made using the tests and test methods described below.

Tensile properties were measured in accordance with ASTM D638 or ISO 527 at a test speed of 50 mm/min on standard tensile bars.

Flexural properties were measured in accordance with ASTM D790 at a test speed of 2.54 mm/min or ISO178 standard at a test speed of 2 mm/min.

Notched Izod impact Strength (INI) was determined in accordance with ASTM D256 under a load of 5 lbf at different temperatures including a temperature of 23° C., −20° C., or −30° C. All ASTM INI determinations were carried out on sample plaques of 3.2 mm thickness. For the test at −20° C. and −30° C., the test specimens were placed in the freezer for more than 4 hours then taken out for testing at room temperature within five seconds.

Heat deflection temperature (HDT) was determined in accordance with ASTM D648 under a load of 1.82 MPa, ISO 75/Af under a load of 1.8 MPa or ISO 75/Bf under a load of 0.45 MPa.

Light transmission and haze were characterized according to ASTM D1003 using a color chip having a thickness of 2.54 millimeters.

Flammability tests were performed following the procedure of Underwriter's Laboratory Bulletin 94 entitled “Tests for Flammability of Plastic Materials for Parts in Devices and Appliances” (ISBN 0-7629-0082-2), Fifth Edition, Dated Oct. 29, 1996, incorporating revisions through and including Dec. 12, 2003. Several ratings can be applied based on the rate of burning, time to extinguish, ability to resist dripping, and whether or not drips are burning. According to this procedure, materials can be classified as UL94 HB, V-0, V-1, V-2, 5VA, or 5VB. The test specimens were aged at 23° C., 50% RH for more than 2 days or 70° C. for 168 hours before testing. Specifically, in the UL 94 50W (20 mm) Vertical Burning Flame Test, a set of five flame bars was tested. For each bar, a flame was applied to the bar then removed, and the time required for the bar to self-extinguish (first afterflame time, t1) was noted. The flame was then reapplied and removed, and the time required for the bar to self-extinguish (second afterflame time, t2) and the post-flame glowing time (afterglow time, t3) were noted. To achieve a rating of V-0, the afterflame times t1 and t2 for each individual specimen must have been less than or equal to 10 seconds; and the total afterflame time for all five specimens (t1 plus t2 for all five specimens) must have been less than or equal to 50 seconds; and the second afterflame time plus the afterglow time for each individual specimen (t2+t3) must have been less than or equal to 30 seconds; and no specimen can have flamed or glowed up to the holding clamp; and the cotton indicator cannot have been ignited by flaming particles or drops. To achieve a rating of V-1, the afterflame times t1 and t2 for each individual specimen must bave been less than or equal to 30 seconds; and the total afterflame time for all five specimens (t1 plus t2 for all five specimens) must have been less than or equal to 250 seconds; and the second afterflame time plus the afterglow time for each individual specimen (t2+t3) must have been less than or equal to 60 seconds; and no specimen can have flamed or glowed up to the holding clamp; and the cotton indicator cannot have been ignited by flaming particles or drops. To achieve a rating of V-2, the afterflame times t1 and t2 for each individual specimen must have been less than or equal to 30 seconds; and the total afterflame time for all five specimens (t1 plus t2 for all five specimens) must have been less than or equal to 250 seconds; and the second afterflame time plus the afterglow time for each individual specimen (t2+t3) must have been less than or equal to 60 seconds; and no specimen can have flamed or glowed up to the holding clamp; but the cotton indicator can have been ignited by flaming particles or drops. To achieve a rating of HB, the material must not have a burn rate that exceeds 40 mm per minute over a 75 mm span for specimens having a thickness of 3 to 13 mm, or have a burn rate that exceeds 75 mm per minute over a 75 mm span for specimens having a thickness less than 3.0 mm in a horizontal burning test. If the material ceases to burn before the 100 mm reference mark, an HB rating can also be obtained.

Carbon Footprint of each composition was characterized according to Intergovernmental Panel on Climate Change (IPCC) methodologies (IPCC 2013 GWP100a V1.03).

Compositions and test results are shown in Table 4. In Table 4, the amount of each component is provided in weight percent, based on the total weight of the composition.

TABLE 4

| | Unit | CEx. 1 | Ex. 1 | Ex. 2 | CEx. 2 | Ex. 3 | Ex. 4 | CEx. 3 | Ex. 5 | CEx. 4 | Ex. 6 |
|---|---|---|---|---|---|---|---|---|---|---|---|
| Component | | | | | | | | | | | |
| PCSi-1 | wt % | | | | | | | 83 | 32 | | |
| PCSi-2 | wt % | | | | 17.49 | 20 | | | | | |
| PCSi-3 | wt % | 12 | 12 | 10 | | | 10 | | | | |
| BPA-PC-1 | wt % | | | | | | | | | 20 | 20 |
| PCR-PC | wt % | | 50 | 75 | | 50 | 75 | | 50 | | 50 |
| HFPC | wt % | 52.6 | 32.31 | 5 | 40.94 | 19.81 | 5 | 6 | | 66.069 | 5 |
| LFPC | wt % | 35 | 5 | 9.31 | 37.49 | 5 | 4.31 | 10.94 | 5 | | 14.029 |
| ULFPC | wt % | | | | | | | | 12.64 | | |
| UHFPC | wt % | | | | | | | | | 2 | |
| BPA-PC-2 | wt % | | | | | | | | | 11 | 10 |
| TSAN | wt % | | | | 0.65 | 0.5 | 0.5 | | | | |
| FR-1 | wt % | | | | 2.6 | 4 | 4 | | | | |
| FR-2 | wt % | | | | | | | | | 0.08 | 0.09 |
| UVA-1 | wt % | | | | | | | | 0.3 | | 0.3 |
| UVA-2 | wt % | | 0.3 | 0.3 | | 0.3 | 0.3 | | | | |
| AO-1 | wt % | 0.1 | 0.09 | 0.09 | 0.03 | 0.09 | 0.09 | 0.06 | 0.06 | 0.014 | 0.014 |
| AO-2 | wt % | | | | | | | | | 0.017 | 0.017 |
| AO-3 | wt % | | | | | | | | | 0.05 | 0.05 |
| Si oil-1 | wt % | | | | 0.5 | | 0.5 | | | | |
| SI oil-2 | wt % | | | | | | | | | 0.4 | 0.4 |
| CycloSi | wt % | | | | | | | | | 0.1 | 0.1 |
| PETS | wt % | 0.3 | 0.3 | 0.3 | 0.3 | 0.3 | 0.3 | | | 0.27 | |
| Properties | | | | | | | | | | | |
| MFR | g/10 | 10 | 11 | 11 | 11.5 | 15 | 13 | 10 | 12 | 18 | 9 |
| | min | | | | | | | | | | |
| INI (23 °C) | J/m | 875 | 870 | 920 | 880 | 900 | 790 | 824 | 950 | 600 | 800 |
| INI (−20 °C) | J/m | — | — | — | — | — | — | — | 600 | — | — |
| INI (−30 °C) | J/m | 777 | 740 | 800 | 660 | 600 | 630 | 712 | 320 | — | — |
| Flex. Mod. | MPa | 2170 | 2190 | 2180 | 2190 | 2300 | 2120 | 2180 | 2290 | 2400 | 2400 |
| Flex. Stress | MPa | 90 | 89 | 93 | 88 | 92 | 86 | 92 | 95 | 103 | 100 |
| @ yield | | | | | | | | | | | |
| HDT | °C | 125 | 121 | 122 | 118 | 112 | 113 | 120 | 122 | 120 | 119 |
| Tens. Mod. | MPa | 2020 | 2110 | 2150 | 2110 | 2190 | 2120 | 2180 | 2200 | 2400 | 2390 |
| Tens. | MPa | 54 | 55 | 56 | 56 | 57 | 54 | 57 | 59 | 67 | 62 |
| Stress @ | | | | | | | | | | | |
| yield | | | | | | | | | | | |
| Tens. | % | 6 | 5.6 | 5.7 | 5.8 | 5.3 | 5.5 | 5.6 | 6 | 6 | 6 |
| Elong. @ | | | | | | | | | | | |
| yield | | | | | | | | | | | |
| Tens. | % | 100 | 100 | 100 | 107 | 110 | 100 | 124 | 110 | 80 | 80 |
| Elong. @ | | | | | | | | | | | |
| brk | | | | | | | | | | | |
| Light | % | — | — | — | — | — | — | 82 | 86 | 88 | 88 |
| transmission | | | | | | | | | | | |
| Haze | % | — | — | — | — | — | — | 3 | 2 | — | — |
| UL94 | — | HB at | HB at | HB at | V-0 at | V-0 at | V-0 at | HB at | HB at | V-0 at | V-0 at |
| | | 0.75 mm | 0.4 mm | 0.4 mm | 1.0 mm | 1.0 mm | 1.0 mm | 0.4 mm | 0.4 mm | 1.5 mm | 1.5 mm |
| Carbon | kg | 5.39 | 3.62 | 2.61 | 5.2 | 3.42 | 2.42 | 5.71 | 3.31 | 4.72 | — |
| Footprint | CO₂/ | | | | | | | | | | |
| | kg | | | | | | | | | | |
| | resin | | | | | | | | | | |
| Reduction | % | — | 32.8 | 51.6 | — | 34.2 | 53.5 | — | 42 | — | — |
| of Carbon | | | | | | | | | | | |
| Footprint | | | | | | | | | | | |

TABLE 5

| | Unit | CEx. 5 | Ex. 7 | Ex. 8 | CEx. 6 | Ex. 9 | Ex. 10 |
|---|---|---|---|---|---|---|---|
| Component | | | | | | | |
| PCE | wt % | 45 | 45 | 45 | | | |
| PPPBP-PC | wt % | | | | 17 | 17 | 17 |
| PCR-PC | wt % | | 30 | 54.41 | | 30 | 50 |
| HFPC | wt % | 54.41 | 24.41 | | 69 | | |
| LFPC | wt % | | | | 13.48 | 20.48 | 10.48 |
| UHFPC | wt % | | | | | 32 | 22 |
| UVA-1 | wt % | 0.2 | 0.2 | 0.2 | | | |
| AO-1 | wt % | | | | 0.08 | 0.08 | 0.08 |
| AO-3 | wt % | | | | 0.04 | 0.04 | 0.04 |
| AO-4 | wt % | 0.06 | 0.06 | 0.06 | | | |
| Epoxy | wt % | 0.03 | 0.03 | 0.03 | | | |
| PETS | wt % | 0.3 | 0.3 | 0.3 | 0.3 | 0.3 | 0.3 |
| CB | wt % | | | | 0.1 | 0.1 | 0.1 |
| Properties | | | | | | | |
| MVR | cm³/10 min | 21 | 15 | 18 | 29 | 26 | 28 |
| INI (23 °C) | J/m | 780 | 720 | 700 | 116 | 103 | 95.2 |
| Flex. Mod. | MPa | 2335 | 2366 | 2343 | 2330 | 2346 | 2348 |
| Flex. Stress | MPa | 96 | 99 | 96 | 99 | 100 | 102 |
| @ yield | | | | | | | |
| HDT | °C | 129 | 121 | 119 | 145 | 143 | 144 |
| Tens. Mod. | MPa | 2315 | 2357 | 2397 | | | |
| Tens. | MPa | 65 | 66 | 66 | | | |
| Stress @ | | | | | | | |
| yield | | | | | | | |
| Tens. | MPa | 67 | 73 | 64 | | | |
| Stress @ | | | | | | | |
| brk | | | | | | | |
| Tens. | % | 108 | 119 | 94 | | | |
| Elong. @ | | | | | | | |
| brk | | | | | | | |
| Carbon | kg CO₂/ | 5.5 | 4.51 | 3.7 | 5.74 | 4.66 | 3.93 |
| Footprint | kg resin | | | | | | |
| Reduction | % | — | 18 | 33 | — | 19 | 39 |
| of Carbon | | | | | | | |
| Footprint | | | | | | | |

As shown in Table 4 and 5, despite including high levels of post-consumer recycle polycarbonate in the compositions of Ex. 1-Ex. 10, these examples exhibited comparable mechanical properties and flame retardancy relative to the comparative examples including only virgin materials. Accordingly, the compositions according to the present disclosure can significantly reduce the carbon footprint compared to the comparative examples, thus contributing to sustainability. A significant improvement is therefore provided by the compositions according to the present disclosure.

This disclosure further encompasses the following aspects.

Aspect 1: A thermoplastic composition comprising: 30 to 95 weight percent of a post-consumer recycle polycarbonate; and 5 to 70 weight percent of a polycarbonate-siloxane copolymer, or a polycarbonate-ester, or a branched polycarbonate, or a copolycarbonate comprising carbonate repeating units derived from a bulky bisphenol group; and wherein when the composition comprises the polycarbonate-siloxane copolymer, the branched polycarbonate, or the copolycarbonate comprising phthalimidine carbonate repeating units, the composition further comprises 5 to 65 weight percent of a linear polycarbonate homopolymer comprising at least two of an ultra high flow polycarbonate having a melt flow rate of 55 to 85 g/10 minutes, as determined according to ASTM D1238 at 300° C. and 1.2 kg; a high flow polycarbonate having a melt flow rate of greater than 20 to 54 g/10 minutes, as determined according to ASTM D1238 at 300° C. and 1.2 kg; a low flow polycarbonate having a melt flow rate of 5 to 19 g/10 minutes, as determined according to ASTM D1238 at 300° C. and 1.2 kg; and an ultra-low flow polycarbonate having a melt flow rate of less than 5 g/10 minutes, as determined according to ASTM D1238 at 300° C. and 1.2 kg; wherein weight percent of each component is based on the total weight of the composition.

Aspect 2: The thermoplastic composition of aspect 1, wherein the post-consumer recycle polycarbonate comprises a bisphenol A polycarbonate, preferably wherein the post-consumer recycle polycarbonate has an L value of greater than or equal to 85, preferably greater than or equal to 92, as determined according to ASTM D2244; a yellowness index of less than or equal to 8, preferably less than or equal to 3.5, as determined according to ASTM E313; a transmission of greater than or equal to 70%, preferably greater than or equal to 82% at a thickness of 3 millimeters, determined according to ASTM D 1003; and a haze of less than or equal to 10, preferably less than or equal to 6 at a thickness of 3 mm, determined according to ASTM D 1003.

Aspect 3: The thermoplastic composition of aspect 1 or 2, comprising 25 to 90 weight percent of the post-consumer recycle polycarbonate; 5 to 70 weight percent of the polycarbonate-siloxane copolymer, or the branched polycarbonate, or the copolycarbonate comprising carbonate repeating units derived from a bulky bisphenol group; and 5 to 65 weight percent of the linear polycarbonate homopolymer comprising at least two of an ultra high flow polycarbonate having a melt flow rate of 55 to 85 g/10 minutes, as determined according to ASTM D1238 at 300° C. and 1.2 kg; a high flow polycarbonate having a melt flow rate of greater than 20 to 54 g/10 minutes, as determined according to ASTM D1238 at 300° C. and 1.2 kg; a low flow polycarbonate having a melt flow rate of 5 to 19 g/10 minutes, as determined according to ASTM D1238 at 300° C. and 1.2 kg; and an ultra-low flow polycarbonate having a melt flow rate of less than 5 g/10 minutes, as determined according to ASTM D1238 at 300° C. and 1.2 kg.

Aspect 4: The thermoplastic composition of any of aspects 1 to 3, comprising the polycarbonate copolymer, wherein the polycarbonate-siloxane comprises 5 to 50 weight percent, or 15 to 50 weight percent, or 20 to 40 weight percent, siloxane content based on the weight of the polycarbonate-siloxane copolymer.

Aspect 5: The thermoplastic composition of any of aspects 1 to 3, comprising the copolycarbonate comprising carbonate repeating units derived from a bulky bisphenol group, preferably a copolycarbonate comprising phthalimidine carbonate repeating units, more preferably wherein the copolycarbonate is a bisphenol A carbonate-2-phenyl-3,3′-bis(4-hydroxyphenyl) phthalimidine carbonate copolymer.

Aspect 6: The thermoplastic composition of any of aspects 1 to 3, comprising the branched polycarbonate, preferably wherein the branched polycarbonate is a branched polycarbonate homopolymer comprising a cyanophenol end group.

Aspect 7: The thermoplastic composition of any of aspects 1 to 6, wherein the linear polycarbonate homopolymer comprises the high flow polycarbonate and the low flow polycarbonate, or the low flow polycarbonate and the ultra low flow polycarbonate, or the low flow polycarbonate and the ultra high flow polycarbonate; preferably, wherein the composition comprises the polycarbonate-siloxane copolymer, and the linear polycarbonate homopolymer comprises the high flow polycarbonate and the low flow polycarbonate or the low flow polycarbonate and the ultra low flow polycarbonate; or wherein the composition comprises the copolycarbonate comprising carbonate repeating units derived from a bulky bisphenol group, and the linear polycarbonate homopolymer comprises the low flow polycarbonate and the ultra high flow polycarbonate; or wherein the composition comprises the branched polycarbonate, and the linear polycarbonate homopolymer comprises the high flow polycarbonate and the low flow polycarbonate.

Aspect 8: The thermoplastic composition of any of aspects 1 to 3, comprising 45 to 90 weight percent of the post-consumer recycle polycarbonate; 5 to 35 weight percent of the polycarbonate-siloxane copolymer, and 5 to 40 weight percent of a linear polycarbonate homopolymer comprising the high flow polycarbonate and the low flow polycarbonate; or the low flow polycarbonate and the ultra-low flow polycarbonate.

Aspect 9: The thermoplastic composition of any of aspects 1 to 3, comprising 25 to 55 weight percent of the post-consumer recycle polycarbonate; 10 to 25 weight percent of the copolycarbonate comprising carbonate repeating units derived from a bulky bisphenol group, and 30 to 55 weight percent of a linear polycarbonate homopolymer comprising the low flow polycarbonate and the ultra-high flow polycarbonate.

Aspect 10: The thermoplastic composition of any of aspects 1 to 3, comprising 40 to 60 weight percent of the post-consumer recycle polycarbonate; 10 to 30 weight percent of the branched polycarbonate comprising a cyanophenol end group, and 10 to 30 weight percent of a linear polycarbonate homopolymer comprising the low flow polycarbonate and the high flow polycarbonate.

Aspect 11: The thermoplastic composition of aspect 1 or 2, comprising the polycarbonate-ester, preferably wherein the polycarbonate-ester comprises resorcinol isophthalate and terephthalate repeating units and bisphenol A carbonate repeating units.

Aspect 12: The thermoplastic composition of aspect 11, comprising 20 to 60 weight percent of the post-consumer recycle polycarbonate; 35 to 55 weight percent of the polycarbonate-ester; and optionally, 15 to 35 weight percent of the high flow polycarbonate.

Aspect 13: The thermoplastic composition of any of aspects 1 to 12, further comprising 0.01 to 10 weight percent of a flame retardant.

Aspect 14: A method for the manufacture of the composition of any of aspects 1 to 13, the method comprising melt-mixing the components of the composition.

Aspect 15: An article comprising the composition of any of aspects 1 to 13, preferably wherein the article is a consumer electronic component.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. The term “alkyl” means a branched or straight chain, saturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo atoms (e.g., bromo and fluoro), or only chloro atoms can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl), a thiol (—SH), a thiocyano (—SCN), a tosyl (CH: C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A thermoplastic composition comprising:
30 to 95 weight percent of a post-consumer recycle polycarbonate; and
5 to 70 weight percent of
a polycarbonate-siloxane copolymer, or
a polycarbonate-ester, or
a branched polycarbonate, or
a copolycarbonate comprising carbonate repeating units derived from a bulky bisphenol group; and
wherein when the composition comprises the polycarbonate-siloxane copolymer, the branched polycarbonate, or the copolycarbonate comprising phthalimidine carbonate repeating units, the composition further comprises
5 to 65 weight percent of a linear polycarbonate homopolymer comprising at least two of
an ultra high flow polycarbonate having a melt flow rate of 55 to 85 g/10 minutes, as determined according to ASTM D1238 at 300° C. and 1.2 kg;
a high flow polycarbonate having a melt flow rate of greater than 20 to 54 g/10 minutes, as determined according to ASTM D1238 at 300° C. and 1.2 kg;
a low flow polycarbonate having a melt flow rate of 5 to 19 g/10 minutes, as determined according to ASTM D1238 at 300° C. and 1.2 kg; and
an ultra-low flow polycarbonate having a melt flow rate of less than 5 g/10 minutes, as determined according to ASTM D1238 at 300° C. and 1.2 kg;
wherein weight percent of each component is based on the total weight of the composition.

2. The thermoplastic composition of claim 1, wherein the post-consumer recycle polycarbonate comprises a bisphenol A polycarbonate.

3. The thermoplastic composition of claim 1, comprising
25 to 90 weight percent of the post-consumer recycle polycarbonate;
5 to 70 weight percent of
the polycarbonate-siloxane copolymer, or
the branched polycarbonate, or
the copolycarbonate comprising carbonate repeating units derived from a bulky bisphenol group; and
5 to 65 weight percent of the linear polycarbonate homopolymer comprising at least two of an ultra high flow polycarbonate having a melt flow rate of 55 to 85 g/10 minutes, as determined according to ASTM D1238 at 300° C. and 1.2 kg;
a high flow polycarbonate having a melt flow rate of greater than 20 to 54 g/10 minutes, as determined according to ASTM D1238 at 300° C. and 1.2 kg;
a low flow polycarbonate having a melt flow rate of 5 to 19 g/10 minutes, as determined according to ASTM D1238 at 300° C. and 1.2 kg; and
an ultra-low flow polycarbonate having a melt flow rate of less than 5 g/10 minutes, as determined according to ASTM D1238 at 300° C. and 1.2 kg.

4. The thermoplastic composition of claim 1, comprising the polycarbonate copolymer, wherein the polycarbonate-siloxane comprises 5 to 50 weight percent, or 15 to 50 weight percent, or 20 to 40 weight percent, or 25 to 50 weight percent, siloxane content based on the weight of the polycarbonate-siloxane copolymer.

5. The thermoplastic composition of claim 1, comprising the copolycarbonate comprising carbonate repeating units derived from a bulky bisphenol group.

6. The thermoplastic composition of claim 1, comprising the branched polycarbonate.

7. The thermoplastic composition of claim 1, wherein the linear polycarbonate homopolymer comprises
the high flow polycarbonate and the low flow polycarbonate, or
the low flow polycarbonate and the ultra low flow polycarbonate, or
the low flow polycarbonate and the ultra high flow polycarbonate.

8. The thermoplastic composition of claim 1 any of claims 1 to 3, comprising
45 to 90 weight percent of the post-consumer recycle polycarbonate;
5 to 35 weight percent of the polycarbonate-siloxane copolymer, and
5 to 40 weight percent of a linear polycarbonate homopolymer comprising
the high flow polycarbonate and the low flow polycarbonate; or
the low flow polycarbonate and the ultra-low flow polycarbonate.

9. The thermoplastic composition of claim 1, comprising
25 to 55 weight percent of the post-consumer recycle polycarbonate;
10 to 25 weight percent of the copolycarbonate comprising carbonate repeating units derived from a bulky bisphenol group, and
30 to 55 weight percent of a linear polycarbonate homopolymer comprising the low flow polycarbonate and the ultra-high flow polycarbonate.

10. The thermoplastic composition of claim 1 any of claims 1 to 3, comprising
40 to 60 weight percent of the post-consumer recycle polycarbonate;
10 to 30 weight percent of the branched polycarbonate comprising a cyanophenol end group, and
10 to 30 weight percent of a linear polycarbonate homopolymer comprising the low flow polycarbonate and the high flow polycarbonate.

11. The thermoplastic composition of claim 1, comprising the polycarbonate-ester.

12. The thermoplastic composition of claim 11, comprising
20 to 60 weight percent of the post-consumer recycle polycarbonate;
35 to 55 weight percent of the polycarbonate-ester; and
optionally, 15 to 35 weight percent of the high flow polycarbonate.

13. The thermoplastic composition of claim 1, further comprising 0.01 to 10 weight percent of a flame retardant.

14. A method for the manufacture of the composition of claim 1, the method comprising melt-mixing the components of the composition.

15. An article comprising the composition of claim 1.

16. The thermoplastic composition of claim 1, wherein the post-consumer recycle polycarbonate has:
an L value of greater than or equal to 85, as determined according to ASTM D2244;
a yellowness index of less than or equal to 8, as determined according to ASTM E313;
a transmission of greater than or equal to 70%, at a thickness of 3 millimeters, determined according to ASTM D 1003; and
a haze of less than or equal to 10 at a thickness of 3 mm, determined according to ASTM D 1003.

17. The thermoplastic composition of claim 1, comprising the copolycarbonate comprising carbonate repeating units derived from a bulky bisphenol group, wherein the copolycarbonate is a bisphenol A carbonate-2-phenyl-3,3′-bis(4-hydroxyphenyl) phthalimidine carbonate copolymer.

18. The thermoplastic composition of claim 1, comprising the branched polycarbonate, wherein the branched polycarbonate is a branched polycarbonate homopolymer comprising a cyanophenol end group

19. The thermoplastic composition of claim 7,
wherein the composition comprises the polycarbonate-siloxane copolymer, and the linear polycarbonate homopolymer comprises the high flow polycarbonate and the low flow polycarbonate or the low flow polycarbonate and the ultra low flow polycarbonate; or
wherein the composition comprises the copolycarbonate comprising carbonate repeating units derived from a bulky bisphenol group, and the linear polycarbonate homopolymer comprises the low flow polycarbonate and the ultra high flow polycarbonate; or
wherein the composition comprises the branched polycarbonate, and the linear polycarbonate homopolymer comprises the high flow polycarbonate and the low flow polycarbonate.

20. The thermoplastic composition of claim 1, comprising the polycarbonate-ester, wherein the polycarbonate-ester comprises resorcinol isophthalate and terephthalate repeating units and bisphenol A carbonate repeating units.
